(19) United States
(12) Patent Application Publication
(10) Pub. No.: US 2007/0052504 A1
(43) Pub. Date: Mar. 8, 2007

(54) Waveguide/strip line converter

(75) Inventor: Akihisa Fujita, Anjo-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/516,184

(22) Filed: Sep. 6, 2006

(30) Foreign Application Priority Data
Sep. 7, 2005 (JP) 2005-259692

(51) Int. Cl. H01P 3/08

(52) U.S. Cl. 333/238

(57) ABSTRACT

A waveguide/strip line converter includes a waveguide and a multilayer substrate. A second end of the multilayer substrate is fixed to an opening of the waveguide. The multilayer substrate includes a plurality of dielectric layers to form a plurality of substrate faces. A top substrate face includes a strip line and a first short-circuiting metal pattern. First and second intermediate substrate faces include second and third short-circuiting metal patterns with openings, respectively. A matching element forming substrate face includes a matching element, which is electromagnetically coupled with the strip line. A waveguide passage extends through the openings between the strip line and the matching element. A cross sectional area of the opening is larger than that of the opening.

### CROSS REFERENCE TO RELATED APPLICATION

This application is based on and incorporates herein by reference Japanese Patent Application No. 2005-259692 filed on Sep. 7, 2005.

### BACKGROUND OF THE INVENTION

1. Field of the Invention

The present invention relates to a waveguide/strip line converter, which converts electric power in a microwave or millimeter wave band.

2. Description of Related Art

A waveguide/strip line converter conventionally includes a short-circuiting layer (a metal layer), a matching element, and a dielectric substrate (e.g., JP-2000-244212-A (corresponding to U.S. Pat. No. 6,580,335)). The short-circuiting layer has a slit, which is disposed at an opening of a waveguide. The matching element is disposed on an inner side of the waveguide, and the short-circuiting layer and the matching element are disposed generally parallel to each other with a predetermined gap formed therebetween. The dielectric substrate is provided in this predetermined gap. The matching element and a strip line, which is formed in the slit of the short-circuiting layer, are electromagnetically connected as a result of disposing them close to each other. A conversion of electric power by means of this electromagnetic connection of the matching element and the strip line eliminates the use of a short-circuiting waveguide block.

According to the above conventional art, a high frequency circuit is arranged on the substrate on which the strip line is formed. When a power supply line to drive the high frequency circuit is formed on the same substrate on which the strip line is formed, an electric current circulating through the power supply line sometimes has an influence on the strip line. The influence on the strip line can be reduced, for example, by including a multilayer substrate in the converter, and by forming the power supply line on a different substrate from the substrate on which the strip line is formed.

When the converter includes the multilayer substrate, a waveguide passage, through which a radio wave propagates, is formed between the strip line and the matching element. For instance, due to a positional shift, which is generated between adjacent substrates while the multilayer substrate is being produced, the waveguide passage on a lower layer side of a grounding metal pattern of the strip line protrudes into an inner side of the waveguide passage that is formed on the grounding metal pattern. As a result, a resonance characteristic of the matching element, that is, a characteristic of the converter deteriorates.

### SUMMARY OF THE INVENTION

The present invention addresses the above disadvantages. Thus, it is an objective to provide a waveguide/strip line converter that can reduce deterioration in the characteristic of the converter, which includes a multilayer substrate.

To achieve the objective of the present invention, there is provided a waveguide/strip line converter, which includes a waveguide and a multilayer substrate. The multilayer substrate has a first end and a second end, which are opposed to each other. The second end of the multilayer substrate is fixed to an opening of the waveguide. The multilayer substrate includes a plurality of dielectric layers, which are stacked one after another between the first end and the second end of the multilayer substrate in a stacking direction to form a plurality of substrate faces. The plurality of substrate faces includes a top substrate face, a first intermediate substrate face, a second intermediate substrate face, and a matching element forming substrate face. The top substrate face is placed in the first end of the multilayer substrate and includes a strip line and a first short-circuiting metal pattern, which are spaced from each other. The first intermediate substrate face is positioned on a waveguide side of the top substrate face in the stacking direction and includes a second short-circuiting metal pattern, which has an opening. The second intermediate substrate face is positioned on a waveguide side of the first intermediate substrate face in the stacking direction and includes a third short-circuiting metal pattern, which has an opening. The matching element forming substrate face is positioned on a waveguide side of the second intermediate substrate face and includes a matching element, which is electromagnetically coupled with the strip line. A waveguide passage is formed to extend through the opening of the second short-circuiting metal pattern and the opening of the third short-circuiting metal pattern in the stacking direction between the strip line and the matching element in the multilayer substrate. The first short-circuiting metal pattern, the second short-circuiting metal pattern, the third short-circuiting metal pattern and the waveguide are grounded together. A cross sectional area of the opening of the third short-circuiting metal pattern is larger than a cross sectional area of the opening of the second short-circuiting metal pattern.

To achieve the objective of the present invention, there is also provided a waveguide/strip line converter, which includes a waveguide and a multilayer substrate. The multilayer substrate has a first end and a second end, which are opposed to each other. The second end of the multilayer substrate is fixed to an opening of the waveguide. The multilayer substrate includes a plurality of dielectric layers that are stacked one after another between the first end and the second end of the multilayer substrate in a stacking direction to form a plurality of substrate faces. The plurality of substrate faces includes a top substrate face, a first intermediate substrate face, a second intermediate substrate face, and a matching element forming substrate face. The top substrate face is placed in the first end of the multilayer substrate and includes a strip line and a first short-circuiting metal pattern, which are spaced from each other. The first intermediate substrate face is positioned on a waveguide side of the top substrate face in the stacking direction and includes a second short-circuiting metal pattern, which has an opening. The second intermediate substrate face is positioned on a waveguide side of the first intermediate substrate face in the stacking direction and includes a third short-circuiting metal pattern, which has an opening. The matching element forming substrate face is positioned on a waveguide side of the second intermediate substrate face and includes a matching element, which is electromagnetically coupled with the strip line. A waveguide passage is formed to extend through the opening of the second short-circuiting metal pattern and the opening of the third short-circuiting metal pattern in the stacking direction between the strip line and the matching element in the multilayer substrate. The first short-circuiting metal pattern, the second short-circuiting metal pattern, the third short-circuiting metal pattern and the waveguide are grounded together. A portion of an inner edge of the opening of the third short-circuiting metal pattern, which is overlapped with the strip line in the stacking direction, is further recessed away from a center axis of the wave guide in comparison to a portion of an inner edge of the opening of the second short-circuiting metal pattern, which is overlapped with the strip line in the stacking direction.

### BRIEF DESCRIPTION OF THE DRAWINGS

The invention, together with additional objectives, features and advantages thereof, will be best understood from the following description, the appended claims and the accompanying drawings in which:

FIG. 1 is a perspective view of a waveguide/strip line converter according to an embodiment of the present invention;

FIG. 2A is a cross-sectional view of the waveguide/strip line converter taken along a line IIA-IIA in FIG. 2B according to the embodiment;

FIG. 2B is a plan view of a top substrate face of a multilayer substrate according to the embodiment;

FIG. 2C is a plan view of a first intermediate substrate face of the multilayer substrate according to the embodiment;

FIG. 2D is a plan view of a second intermediate substrate face of the multilayer substrate according to the embodiment;

FIG. 2E is a plan view of a matching element forming substrate face of the multilayer substrate according to the embodiment;

FIG. 3A is a cross-sectional view of the waveguide/strip line converter taken along a line IIIA-IIIA in FIG. 3B, which illustrates an application of a high frequency circuit and a power supply line to the multilayer substrate according to the embodiment;

FIG. 3B is a plan view of the top substrate face of the multilayer substrate, to which the high frequency circuit and the power supply line are applied, according to the embodiment;

FIG. 3C is a plan view of the first intermediate substrate face of the multilayer substrate, to which the power supply line is applied, according to the embodiment;

FIG. 3D is a plan view of the second intermediate substrate face of the multilayer substrate, to which the power supply line is applied, according to the embodiment;

FIG. 3E is a plan view of the matching element forming substrate face of the multilayer substrate according to the embodiment;

FIG. 3F is a cross-sectional view of the waveguide/strip line converter taken along a line IIIF-IIIF in FIG. 3B, which illustrates an application of a high frequency circuit and a power supply line to the multilayer substrate according to the embodiment;

FIG. 4A is a cross-sectional view of the waveguide/strip line converter taken along a line IVA-IVA in FIG. 4B according to a first modification of the embodiment;

FIG. 4B is a plan view of the matching element forming substrate face of the multilayer substrate according to the first modification of the embodiment;

FIG. 4C is a cross-sectional view of the waveguide/strip line converter similar to FIG. 4A, illustrating a problematic greater protrusion of a portion of an inner edge of an opening of a third short-circuiting metal pattern, which is overlapped with a strip line in a stacking direction, towards a center axis of a waveguide, as compared to a portion of an inner edge of an opening of a second short-circuiting metal pattern, which is overlapped with the strip line in the stacking direction;

FIG. 4D is a cross-sectional view of the waveguide/strip line converter according to the first modification of the embodiment;

FIG. 5A is a cross-sectional view of the waveguide/strip line converter taken along a line VA-VA in FIG. 5B according to a second modification of the embodiment;

FIG. 5B is a plan view of a (n-1)th substrate face of the multilayer substrate according to the second modification of the embodiment;

FIG. 5C is a plan view of an nth substrate face of the multilayer substrate according to the second modification of the embodiment;

FIG. 6A is a cross-sectional view of the waveguide/strip line converter taken along a line VIA-VIA in FIG. 6B according to the second modification of the embodiment;

FIG. 6B is a plan view of the (n-1)th substrate face of the multilayer substrate according to the second modification of the embodiment; and

FIG. 6C is a plan view of the nth substrate face of the multilayer substrate according to the second modification of the embodiment.

### DETAILED DESCRIPTION OF THE INVENTION

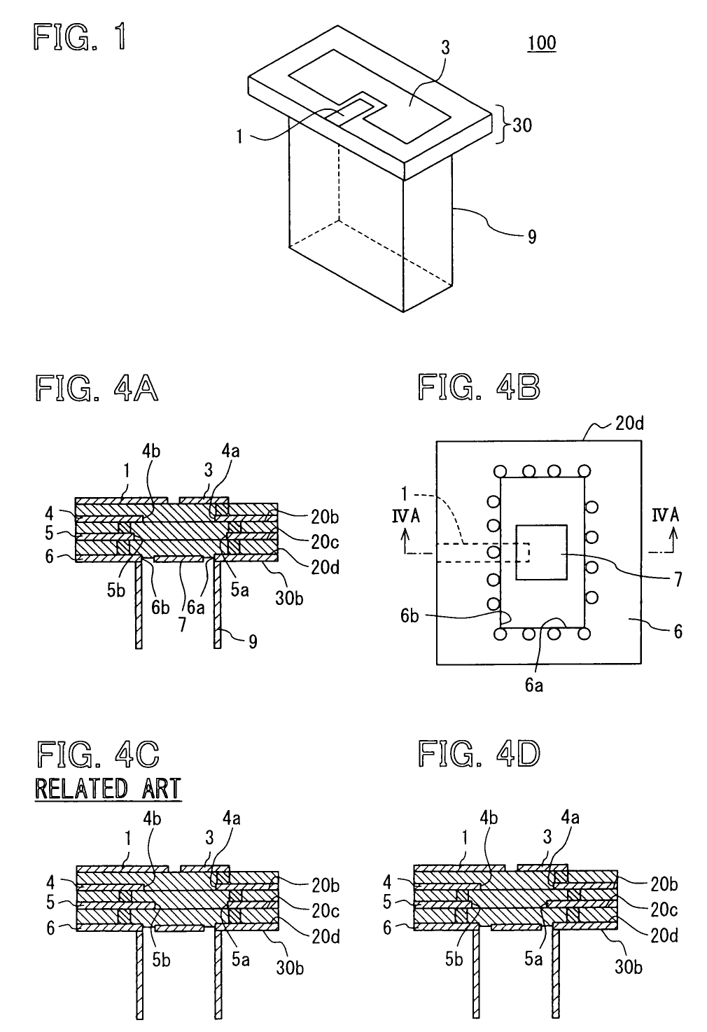

Embodiments will be described below with reference to drawings. FIG. 1 is a perspective view of a waveguide/strip line converter 100. As shown in FIG. 1, the waveguide/strip line converter 100 of the present embodiment is a converter having a multilayer substrate structure. A radio wave with a microwave or millimeter wave band enters through or/and is emitted from one end (i.e., a lower end in FIG. 1) of a waveguide 9 of the waveguide/strip line converter 100. A multilayer substrate 30 is disposed at an opening 9a at the other end (i.e., an upper end in FIG. 1) of the waveguide 9.

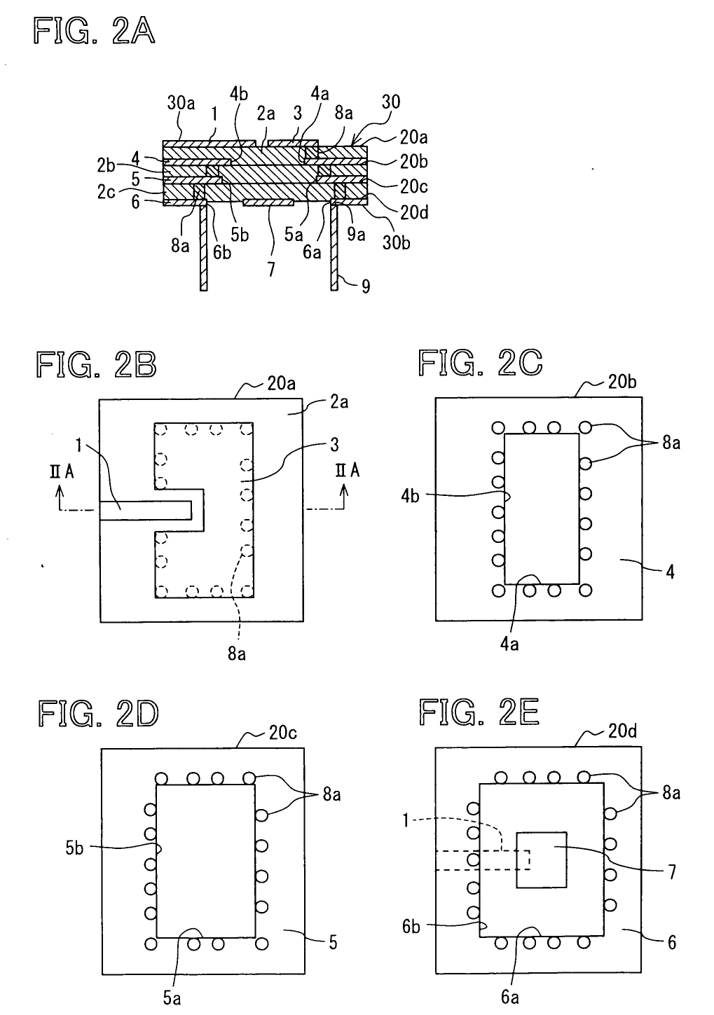

FIGS. 2A to 2E show the multilayer substrate structure. The multilayer substrate 30 includes a plurality of dielectric layers 2a to 2c, which are stacked one after another. FIG. 2A is a cross-sectional view of the waveguide/strip line converter 100. FIGS. 2B, 2C, 2D, 2E are plan views of a top substrate face 20a, a first intermediate substrate face 20b, a second intermediate substrate face 20c, and a matching element forming substrate face 20d of the multiplayer substrate 30, respectively. The top substrate face 20a is placed in a first end 30a of the multiplayer substrate 30. Furthermore, the matching element forming substrate face 20d is placed in a second end 30b of the multiplayer substrate 30, which is opposed to the first end 30a of the multiplayer substrate 30.

As shown in FIG. 2B, a microstrip line (MSL) 1 is disposed on the top substrate face 20a of the dielectric layer 2a of the multilayer substrate 30. A first short-circuiting metal pattern 3 is placed in the top substrate face 20a in such a manner that the first short-circuiting metal pattern 3 is spaced from the MSL 1 by a predetermined distance.

As shown in FIG. 2C, a second short-circuiting metal pattern 4 is disposed in the first intermediate substrate face 20b formed between the dielectric layer 2a and the dielectric layer 2b of the multilayer substrate 30. An opening 4a is formed as a waveguide passage in a central region of the second short-circuiting metal pattern 4. Likewise, a third short-circuiting metal pattern 5 is placed in the second intermediate substrate face 20c formed between the dielectric layer 2b and the dielectric layer 2c of the multilayer substrate 30, as shown in FIG. 2D. An opening 5a is formed as the waveguide passage in a central region of the third short-circuiting metal pattern 5.

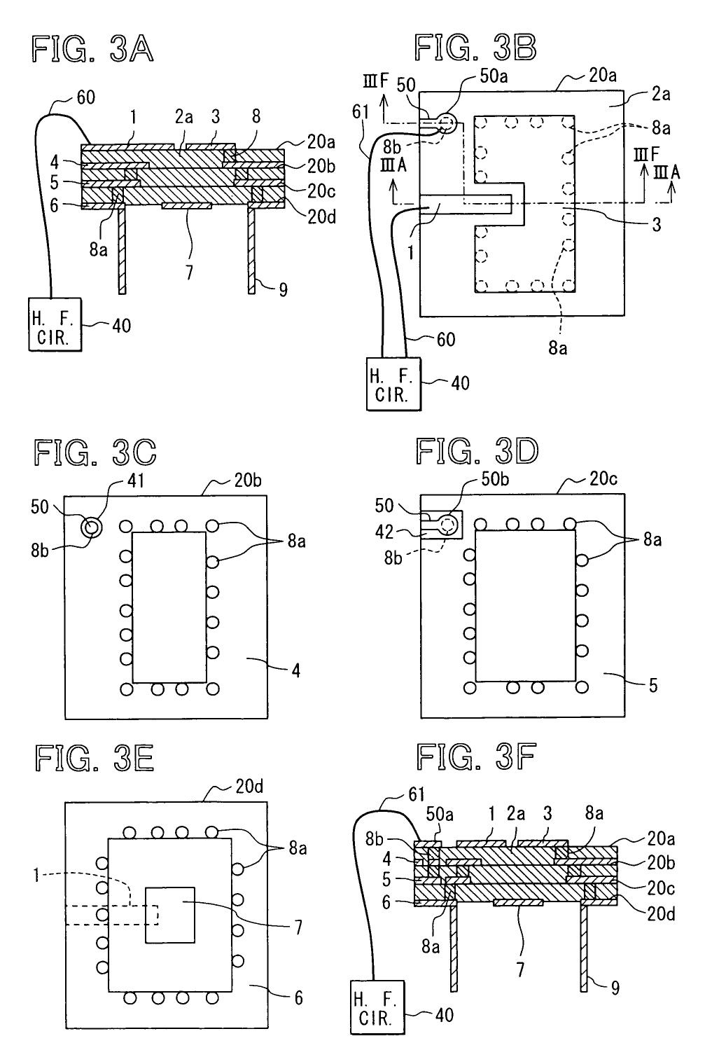

In addition, as shown in FIGS. 3A, 3B, 3C, 3D, 3F, a power supply line 50 to drive the MSL 1 or a high frequency circuit 40, for example, may be placed in the second intermediate substrate face 20c. The power supply line 50 includes a conductive line 50a, a via 8b, and a conductive line 50b. Insulating regions 41, 42 are parts of the dielectric layer 2b and the dielectric layer 2c, respectively. In the insulating regions 41, 42, the corresponding second and the third short-circuiting metal patterns 4, 5 are not formed. The high frequency circuit 40 is fed with electric power by the power supply line 50, which is electrically connected to the high frequency circuit 40, through the via 8b that penetrates through the multilayer substrate 30 up to the top substrate face 20a. Then, the via 8b is connected to the high frequency circuit 40 through, for example, a wire 61 (FIGS. 3B, 3F). The high frequency circuit 40 may be connected to the MSL 1 by, for example, a wire 60 (FIGS. 3A, 3B). Accordingly, a resulting high-frequency connection between the power supply line 50 and the MSL 1 can reduce deterioration in a signal of the MSL 1.

As shown in FIG. 2E, a fourth short-circuiting metal pattern 6 and a matching element 7 are placed on the matching element forming substrate face 20d of the multilayer substrate 30. An opening 6a is formed as the waveguide passage in a central region of the fourth short-circuiting metal pattern 6. The fourth short-circuiting metal pattern 6 is electrically connected and secured to the upper opening 9a of the waveguide 9 by a welding or a soldering. Consequently, the multilayer substrate 30 is secured to the opening 9a at the other end of the waveguide 9.

Besides, as shown in FIG. 2A, the first short-circuiting metal pattern 3 on the top substrate face 20a, the second short-circuiting metal pattern 4 in the first intermediate substrate face 20b, the third short-circuiting metal pattern 5 in the second intermediate substrate face 20c, and the fourth short-circuiting metal pattern 6 on the matching element forming substrate face 20d are electrically connected to one another through vias 8a, thereby being maintained at the same potential (including the waveguide 9). Additionally, these conductors (i.e., the MSL 1, the first short-circuiting metal pattern 3 on the top substrate face 20a, the second short-circuiting metal pattern 4 in the first intermediate substrate face 20b, the third short-circuiting metal pattern 5 in the second intermediate substrate face 20c, the power supply line 50, and the fourth short-circuiting metal pattern 6 on the matching element forming substrate face 20d) are formed by a process such as a photoetching.

As shown in FIG. 2A, since the second short-circuiting metal pattern 4 is placed in the first intermediate substrate face 20b, which is different from the substrate face (i.e., 20d) where the matching element 7 is disposed, the MSL 1 can be formed with a minimum substrate thickness as well as in a relatively narrow width, thereby reducing a size of the MSL 1.

Next, a characteristic part of the waveguide/strip line converter 100 will be described below. As in the case of the present embodiment, when the waveguide/strip line converter 100 includes the multilayer substrate 30, the waveguide passage (i.e., the above openings 4a, 5a), through which a radio wave propagates, is formed between the MSL 1 and the matching element 7. For instance, it can be assumed that the openings (i.e., the openings 5a, 6a), which are formed on a waveguide 9 side of the first intermediate substrate face 20b in a stacking direction, have approximately the same cross sectional areas as the opening 4a. In such a case, if a positional shift is generated between adjacent layers (the dielectric layers 2a to 2c) while the multilayer substrate 30 is being produced, inner edges of the above openings (i.e., inner edges 5b, 6b, respectively) may further protrude towards a center axis of the waveguide 9, as compared to a portion of an inner edge 4b of the opening 4a, which is overlapped with these inner edges in the stacking direction. As a result, a resonance characteristic of the matching element 7 (i.e., a characteristic of the converter) deteriorates.

That is to say, because of a strong electromagnetic coupling between the MSL 1 and the matching element 7, arrangement of the third short-circuiting metal pattern 5 and the fourth short-circuiting metal pattern 6 considerably influences the resonance characteristic of the matching element 7. An electromagnetic loss increases particularly when the inner edges 5b, 6b of the respective openings 5a, 6a further protrude towards the center axis of the waveguide 9, as compared to the portion of the inner edge 4b of the opening 4a of the second short-circuiting metal pattern 4, which is overlapped with these inner edges 5b, 6b in the stacking direction. Therefore, although it would be ideal if the multilayer substrate 30 were produced such that there were no positional shifts between adjacent layers, yet practically, the positional shift necessarily exists.

Further protrusions of the inner edges (i.e., the inner edges 5b, 6b) of the openings (i.e., the respective openings 5a, 6a), which are formed on the waveguide 9 side of the first intermediate substrate face 20b in the stacking direction, towards the center axis of the waveguide 9 as compared to the portion of the inner edge 4b of the opening 4a of the second short-circuiting metal pattern 4, which is overlapped with these inner edges in the stacking direction, cause serious deterioration in the converter characteristic. Nevertheless, substantially no deterioration occurs if the inner edges of the openings that are formed on the waveguide 9 side of the first intermediate substrate face 20b in the stacking direction are further recessed away from the center axis of the waveguide 9 as compared to the portion of the inner edge 4b, which is overlapped with these inner edges in the stacking direction. Given the above fact, the present embodiment employs the multilayer substrate structure, which can permit the positional shift between adjacent layers, in producing the multilayer substrate 30.

That is, when a tolerance of±S, for example, is allowed for the positional shift between adjacent layers in producing the multilayer substrate 30, most of the influence of the positional shift, and accordingly the electromagnetic loss can be decreased by recessing each inner edge 5b of the opening 5a and each inner edge 6b of the opening 6a by an amount s from the portion of the inner edge 4b of the opening 4a, which is overlapped with the each inner edge 5b and the each inner edge 6b, respectively in the stacking direction (so that widths of cross sectional areas of the openings 5a, 6a are made larger by 2S (=2×s) than a width of a cross sectional area of the opening 4a).

Thus, as shown in FIGS. 2A to 2E, the widths of the cross sectional areas of the openings 5a, 6a formed in the respective substrate faces 20c, 20d, which are located on the waveguide 9 side of the first intermediate substrate face 20b in the stacking direction, are made larger than the width of the cross sectional area of the opening 4a in the first intermediate substrate face 20b (so that the each inner edge 5b and the each inner edge 6b are overlapped with the inner edge 4b of the opening 4a in the stacking direction ).

As a consequence, despite the positional shift between adjacent layers, the multilayer substrate 30 can be produced, such that the inner edges 5b, 6b of the respective openings 5a, 6a on the waveguide 9 side of the first intermediate substrate face 20b in the stacking direction do not protrude towards the center axis of the waveguide 9, further than the inner edge 4b of the opening 4a of the second short-circuiting metal pattern 4. For this reason, the deterioration in the resonance characteristic of the matching element 7 (i.e., in the converter characteristic) can be reduced.

More specifically, as shown in FIG. 2A, the each inner edge 5b of the opening 5a is further recessed from the center axis of the waveguide 9 as compared to the inner edge 4b of the opening 4a, so that the width of the cross sectional area of the opening 5a is larger than that of the opening 4a. By the same token, the each inner edge 6b of the opening 6a is further recessed from the center axis of the waveguide 9 than the inner edge 5b of the opening 5a, so that the width of the cross sectional area of the opening 6a is larger than that of the opening 5a. Consequently, if more dielectric layers are included in the multilayer substrate 30, as the openings are located further on the waveguide 9 side of the first intermediate substrate face 20b in the stacking direction, the widths of the cross sectional areas of these openings are made larger accordingly.

Thus far, the embodiment of the present invention has been described. However, the present invention is not by any means limited to the above embodiment, and it can be embodied in various ways without departing from the scope of the invention.

(First Modification)

As has been mentioned in the above embodiment, the arrangement of the third short-circuiting metal pattern 5 and the fourth short-circuiting metal pattern 6 considerably influences the resonance characteristic of the matching element 7 due to the strong electromagnetic coupling between the MSL 1 and the matching element 7. In particular, the arrangement of the third short-circuiting metal pattern 5, which is located closer to the MSL 1 in relation to the other metal pattern (i.e., the fourth short-circuiting metal pattern 6) located on the waveguide 9 side of the first intermediate substrate face 20b in the stacking direction, has more significant influence upon the resonance characteristic of the matching element 7 than that of the fourth short-circuiting metal pattern 6. Because of this, as far as the fourth short-circuiting metal pattern 6 is concerned, its opening may take a size, for which the tolerance of±S is not allowed as shown in FIGS. 4A, 4B (i.e., the fourth short-circuiting metal pattern 6 may have the opening 6a of the same size as the opening 4a of the second short-circuiting metal pattern 4).

In addition to the more significant influence of the arrangement of the third short-circuiting metal pattern 5 upon the resonance characteristic of the matching element 7 than that of the fourth short-circuiting metal pattern 6, a comparative example FIG. 4C illustrates the most problematic arrangement of the third short-circuiting metal pattern 5. A further protrusion of a portion of the inner edge 5b of the opening 5a (from which a millimeter wave is transmitted), which is overlapped with the MSL 1 in the stacking direction, towards the center axis of the waveguide 9, in comparison to the inner edge 4b of the opening 4a, which is overlapped with the MSL 1 in the stacking direction, causes the most serious deterioration in the signal of the MSL 1. Consequently, the signal loss can be best reduced if a width of a cross sectional area of an opening of a short-circuiting metal pattern (i.e., the opening 5a of the third short-circuiting metal pattern 5), which is located closest to the MSL 1 among the metal pattern(s) placed on the waveguide 9 side of the first intermediate substrate face 20b in the stacking direction, is larger than the width of the cross sectional area of the opening 4a by more than the positional shift tolerance, provided that the portion of the inner edge 5b of the opening 5a, which is overlapped with the MSL 1 in the stacking direction, is further recessed away from the center axis of the waveguide 9 in comparison to the portion of the inner edge 4b of the opening 4a, which is overlapped with the MSL 1 in the stacking direction (see FIG. 4D).

(Second Modification)

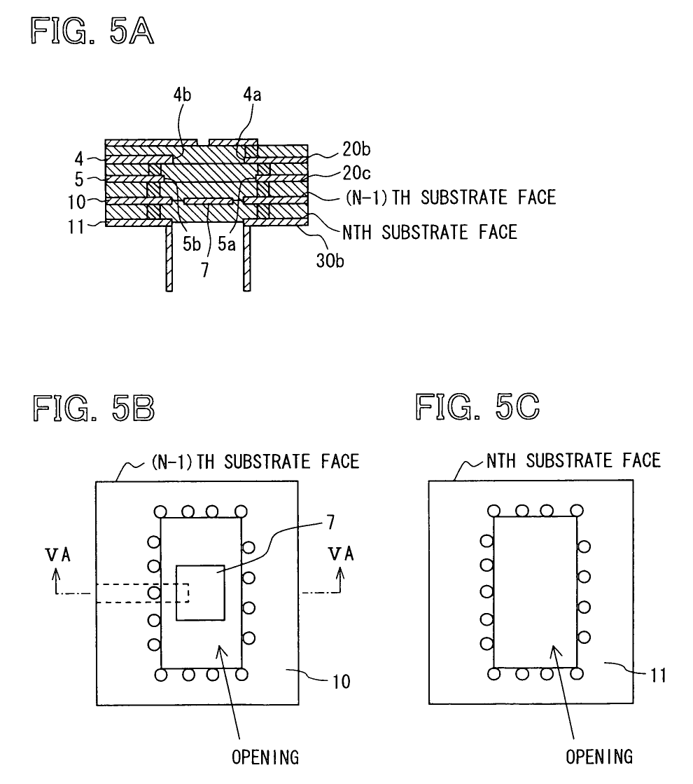

FIGS. 5A to 5C show the multilayer substrate structure of the present modification. FIG. 5A is a cross-sectional view of the waveguide/strip line converter 100. FIGS. 5B, 5C are plan views of (n-1)th and nth substrate faces of the multilayer substrate, respectively.

As shown in FIG. 5B, the matching element 7 and a short-circuiting metal pattern 10 are disposed in the (n-1)th substrate face. An opening is formed as the waveguide passage in a central region of the short-circuiting metal pattern 10. Also, as shown in FIG. 5C, a short-circuiting metal pattern 11 included in the second end 30b of the multilayer substrate 30 is disposed on the nth substrate face. By the same token, an opening is formed as the waveguide passage in a central region of the short-circuiting metal pattern 11.

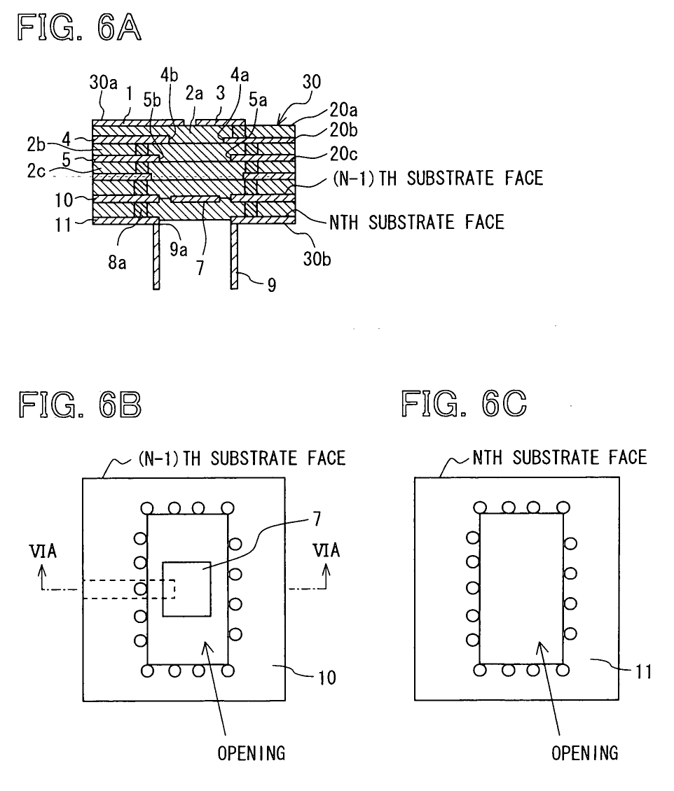

Even though the matching element 7 is disposed in the substrate face, which is located between the first intermediate substrate face 20b and the nth substrate face (on which the short-circuiting metal pattern 11 is placed), the deterioration in the resonance characteristic of the matching element 7 can be reduced if each inner edge of an opening formed between the second intermediate substrate face 20c and the nth substrate face is further recessed from the center axis of the waveguide 9 as compared to the inner edge 4b of the opening 4a, so that widths of cross sectional areas of the openings between the second intermediate substrate face 20c and the nth substrate face are larger than the width of the cross sectional area of the opening 4a. That is, making larger the widths of the cross sectional areas of the openings that are located on the waveguide 9 side of the first intermediate substrate face 20b in the stacking direction than the width of the cross sectional area of the opening 4a in the first intermediate substrate face 20b can reduce the deterioration in the resonance characteristic of the matching element 7 (i.e., in the converter characteristic). FIGS. 6A to 6C show the multilayer substrate 30, in which two substrate faces are formed between the second intermediate substrate face 20c and the nth substrate face.

(Third Modification)

In the above embodiment and the modifications, the matching element 7 has had a quadrangular shape when shown in plan view. However, the matching element 7 is not restricted to any particular shape. In fact, a round shape, a ring shape or the like may be employed for the matching element 7. In addition, the waveguide 9 may be filled with dielectric materials or the like, which has not been mentioned in the above embodiments.

Additional advantages and modifications will readily occur to those skilled in the art. The invention in its broader terms is therefore not limited to the specific details, representative apparatus, and illustrative examples shown and described.

What is claimed is:

1. A waveguide/strip line converter comprising:
a waveguide; and
a multilayer substrate that has a first end and a second end, which are opposed to each other, wherein the second end of the multilayer substrate is fixed to an opening of the waveguide, and the multilayer substrate includes a plurality of dielectric layers that are stacked one after another between the first end and the second end of the multilayer substrate in a stacking direction to form a plurality of substrate faces, which include:
a top substrate face that is placed in the first end of the multilayer substrate and includes a strip line and a first short-circuiting metal pattern, which are spaced from each other;
a first intermediate substrate face that is positioned on a waveguide side of the top substrate face in the stacking direction and includes a second short-circuiting metal pattern, which has an opening;
a second intermediate substrate face that is positioned on a waveguide side of the first intermediate substrate face in the stacking direction and includes a third short-circuiting metal pattern, which has an opening; and
a matching element forming substrate face that is positioned on a waveguide side of the second intermediate substrate face and includes a matching element, which is electromagnetically coupled with the strip line, wherein:
a waveguide passage is formed to extend through the opening of the second short-circuiting metal pattern and the opening of the third short-circuiting metal pattern in the stacking direction between the strip line and the matching element in the multilayer substrate;
the first short-circuiting metal pattern, the second short-circuiting metal pattern, the third short-circuiting metal pattern and the waveguide are grounded together; and
a cross sectional area of the opening of the third short-circuiting metal pattern is larger than a cross sectional area of the opening of the second short-circuiting metal pattern.

2. The waveguide/strip line converter according to claim 1, wherein:
the plurality of substrate faces further includes at least one additional intermediate substrate face, which is positioned between the second-intermediate substrate face and the matching element forming substrate face;
each of the at least one additional intermediate substrate face includes a short-circuiting metal pattern that is grounded together with the second and third short-circuiting metal patterns and has an opening, through which the waveguide passage extends in the stacking direction; and
a cross sectional area of the opening of the short-circuiting metal pattern of each of the at least one additional intermediate substrate face is larger than that of the opening of the third short-circuiting metal pattern.

3. The waveguide/strip line converter according to claim 1, wherein the matching element forming substrate face is positioned in the second end of the multilayer substrate.

4. The waveguide/strip line converter according to claim 1, wherein the matching element forming substrate face is spaced from the second end of the multilayer substrate on a top substrate face side of the second end of the multilayer substrate in the stacking direction.

5. The waveguide/strip line converter according to claim 1, further comprising a high frequency circuit that is connected to the strip line, wherein one of the plurality of substrate faces other than the top substrate face includes a power supply line, which is connected to the high frequency circuit to drive the high frequency circuit.

6. A waveguide/strip line converter comprising:
a waveguide; and
a multilayer substrate that has a first end and a second end, which are opposed to each other, wherein the second end of the multilayer substrate is fixed to an opening of the waveguide, and the multilayer substrate includes a plurality of dielectric layers that are stacked one after another between the first end and the second end of the multilayer substrate in a stacking direction to form a plurality of substrate faces, which include:
a top substrate face that is placed in the first end of the multilayer substrate and includes a strip line and a first short-circuiting metal pattern, which are spaced from each other;
a first intermediate substrate face that is positioned on a waveguide side of the top substrate face in the stacking direction and includes a second short-circuiting metal pattern, which has an opening;
a second intermediate substrate face that is positioned on a waveguide side of the first intermediate substrate face in the stacking direction and includes a third short-circuiting metal pattern, which has an opening; and
a matching element forming substrate face that is positioned on a waveguide side of the second intermediate substrate face and includes a matching element, which is electromagnetically coupled with the strip line, wherein:
a waveguide passage is formed to extend through the opening of the second short-circuiting metal pattern and the opening of the third short-circuiting metal pattern in the stacking direction between the strip line and the matching element in the multilayer substrate;
the first short-circuiting metal pattern, the second short-circuiting metal pattern, the third short-circuiting metal pattern and the waveguide are grounded together; and
a portion of an inner edge of the opening of the third short-circuiting metal pattern, which is overlapped with the strip line in the stacking direction, is further recessed away from a center axis of the wave guide in comparison to a portion of an inner edge of the opening of the second short-circuiting metal pattern, which is overlapped with the strip line in the stacking direction.

7. The waveguide/strip line converter according to claim 6, wherein a cross sectional area of the opening of the third short-circuiting metal pattern is larger than a cross sectional area of the opening of the second short-circuiting metal pattern.

8. The waveguide/strip line converter according to claim 7, wherein:
the plurality of substrate faces further includes at least one additional intermediate substrate face, which is positioned between the second-intermediate substrate face and the matching element forming substrate face;
each of the at least one additional intermediate substrate face includes a short-circuiting metal pattern that is grounded together with the second and third short-circuiting metal patterns and has an opening, through which the waveguide passage extends in the stacking direction; and
a cross sectional area of the opening of the short-circuiting metal pattern of each of the at least one additional intermediate substrate face is larger than that of the opening of the third short-circuiting metal pattern.

9. The waveguide/strip line converter according to claim 6, wherein the matching element forming substrate face is positioned in the second end of the multilayer substrate.

10. The waveguide/strip line converter according to claim 6, wherein the matching element forming substrate face is spaced from the second end of the multilayer substrate on a top substrate face side of the second end of the multilayer substrate in the stacking direction.

11. The waveguide/strip line converter according to claim 6, further comprising a high frequency circuit that is connected to the strip line, wherein one of the plurality of substrate faces other than the top substrate face includes a power supply line, which is connected to the high frequency circuit to drive the high frequency circuit.
